(19) United States
(12) Patent Application Publication
(10) Pub. No.: US 2026/0322267 A1
(43) Pub. Date: Oct. 15, 2026

(54) SWITCHING POWER SUPPLY CIRCUIT, CHARGING AND DISCHARGING METHOD, AND CHARGING AND DISCHARGING DEVICE

(71) Applicant: ZHUHAI ISMARTWARE TECHNOLOGY CO., LTD., Zhuhai, Guangdong (CN)

(72) Inventors: Qin DENG, Zhuhai, Guangdong (CN); Li DU, Zhuhai, Guangdong (CN); Jin LI, Zhuhai, Guangdong (CN); Wanjia HAN, Zhuhai, Guangdong (CN)

(21) Appl. No.: 19/149,036

(22) PCT Filed: Apr. 28, 2024
(86) PCT No.: PCT/CN2024/090429

§ 371 Date: Jul. 17, 2025

(30) Foreign Application Priority Data
Aug. 8, 2023 (CN) 202310998515.4

(51) Int. Cl. H02M 3/158; H02J 7/00; H02M 1/088

(52) U.S. Cl. CPC H02M 3/1582; H02J 7/855; H02M 1/088; H02J 2207/20

(57) ABSTRACT

A switching power supply circuit, a charging and discharging method, and a charging and discharging device are provided, relating to the technical field of power management. The switching power supply circuit includes a first node, a second node, a buck-boost conversion circuit coupled between the first node and the second node, an auxiliary conversion circuit, and a control circuit. The control circuit is configured to activate the buck-boost conversion circuit and/or a first auxiliary conversion circuit based on a first voltage at the first node and a second voltage at the second node.

### CROSS REFERENCE TO RELATED APPLICATION

This patent application is a U.S. national stage application of International Patent Application No. PCT/CN2024/090429, filed Apr. 28, 2024, which claims the benefit of and priority to Chinese Patent Application No. 202310998515.4, filed Aug. 8, 2023, each of which is hereby incorporated by reference herein in its entirety.

### TECHNICAL FIELD

The present application relates to the technical field of power management, and in particular, to a switching power supply circuit, a charging and discharging method, and a charging and discharging device.

### BACKGROUND

With the widespread use of the fast-charging technology, the charging power of mobile electronic devices such as smartphones or laptops has significantly increased, generally exceeding 100 W, and even surpassing 210 W. Therefore, most mobile electronic devices adopt multi-cell series battery configurations. In the multi-cell series battery configurations, the voltage range of batteries exhibits substantial variation. Taking a battery scheme in which 3 cells are connected in series as an example, the battery voltage typically ranges from approximately 7V to 13V. Existing adapters support diverse output voltages, such as 5V, 9V, 10V, 12V, 15V, and 20V. To ensure compatibility with these varied adapters during charging, mobile electronic devices are increasingly adopting buck-boost switching power supply circuits for charging.

The USB Power Delivery (USB PD) fast charging protocol has released the 3.1 specification, which introduces three new power levels beyond PD3.0's maximum 100 W (20 V 5 A): 140 W (28V, 5 A), 180 W (36 V, 5 A), and 240 W (48 V, 5 A). With the release and growing adoption of PD3.1 specification, 140 W has emerged as the dominant implementation of the standard. As a result, the charging power of laptop batteries is progressively shifting toward 140 W (28 V, 5 A). However, as charging power increases, switching power supply circuits exhibit declining efficiency and significant heat generation issues. Simultaneously, higher current magnitudes cause amplified voltage spikes during the instant of switching state transitions (turn-on to turn-off or vice versa) in power switching transistors. This elevates the electrical stress on the transistors, thereby increasing the risk of power switching transistor failure.

### SUMMARY

The present application is intended to solve at least one of the technical problems existing in the prior art. In view of this, the present application provides a switching power supply circuit, a charging and discharging method, and a charging and discharging device, reducing heat generation, and lowering the risk of power switching transistor losses.

According to a first aspect, the present application provides a switching power supply circuit, including:
a first node and a second node, where during charging, the first node is connected to a power source and the second node outputs power; and during discharging, the first node outputs power and the second node is connected to the power source;
a buck-boost conversion circuit, coupled between the first node and the second node, and configured to operate under control in one of the following modes during the charging or the discharging: boost mode, buck mode, or buck-boost mode;
at least one first auxiliary conversion circuit, connected in parallel with the buck-boost conversion circuit, and configured to operate under control in the buck mode during the charging or the boost mode during the discharging; and
a control circuit, coupled to the buck-boost conversion circuit and the first auxiliary conversion circuit, and configured to activate the buck-boost conversion circuit and/or the first auxiliary conversion circuit based on a first voltage at the first node and a second voltage at the second node.

According to one embodiment of the present application, the control circuit is configured to simultaneously activate the buck-boost conversion circuit and the first auxiliary conversion circuit when the first voltage is greater than a sum of the second voltage and a threshold voltage.

According to one embodiment of the present application, the control circuit is configured to simultaneously activate the buck-boost conversion circuit and the first auxiliary conversion circuit when the first voltage is greater than the sum of the second voltage and the threshold voltage, and a power of the first node is greater than a reference power.

According to one embodiment of the present application, the first auxiliary conversion circuit includes:
a first switch and a second switch connected in series, where one terminal of the first switch is coupled to the first node, and one terminal of the second switch is coupled to a ground node; and
an inductor, coupled between a connection point of the first switch and the second switch and the second node.

According to a second aspect, the present application provides a switching power supply circuit, including:
a first node and a second node, where during charging, the first node is connected to a power source and the second node outputs power; and during discharging, the first node outputs power and the second node is connected to the power source;
a buck-boost conversion circuit, coupled between the first node and the second node, and configured to operate under control in one of the following modes during the charging or the discharging: boost mode, buck mode, or buck-boost mode;
at least one second auxiliary conversion circuit, connected in parallel with the buck-boost conversion circuit, and configured to operate under control in the boost mode during the charging or the buck mode during the discharging; and
a control circuit, coupled to the buck-boost conversion circuit and the second auxiliary conversion circuit, and configured to activate the buck-boost conversion circuit and/or the second auxiliary conversion circuit based on a first voltage at the first node and a second voltage at the second node.

According to one embodiment of the present application, the control circuit is configured to simultaneously activate the buck-boost conversion circuit and the second auxiliary conversion circuit when the second voltage is greater than a sum of the first voltage and a threshold voltage.

According to one embodiment of the present application, the control circuit is configured to simultaneously activate the buck-boost conversion circuit and the second auxiliary conversion circuit when the second voltage is greater than the sum of the first voltage and the threshold voltage, and a power of the first node is greater than a reference power.

According to one embodiment of the present application, the second auxiliary conversion circuit includes:
a third switch and a fourth switch connected in series, where one terminal of the third switch is coupled to the second node, and one terminal of the fourth switch is coupled to a ground node; and
an inductor, coupled between a connection point of the third switch and the fourth switch and the first node.

According to a third aspect, the present application provides a charging and discharging method, which is used for controlling, based on the aforementioned switching power supply circuit, the first node of the switching power supply circuit to be coupled to the power source, and the second node to be coupled to a battery, where the charging and discharging method includes:
obtaining a voltage of the power source and a voltage of the battery; and according to the voltage of the power source and the voltage of the battery, activating the buck-boost conversion circuit and/or the auxiliary conversion circuit for charging or discharging.

According to a fourth aspect, the present application provides a charging and discharging device, where the charging and discharging device includes the aforementioned switching power supply circuit.

According to the switching power supply circuit, the charging and discharging method, and the charging and discharging device of the present application, the switching power supply circuit is equipped with at least two conversion circuits. According to the requirements of charging and discharging, one or multiple conversion circuits can be activated, improving charging efficiency, and achieving boost or buck as needed. When the power is large, the multiple conversion circuits can share the charging power, resulting in reduced current flow through each individual circuit. This mitigates heat generation and lowers the failure risk of power switching transistors.

Additional aspects and advantages of the present application will be partly provided in the following description, and partly become evident in the following description or understood through the practice of the present application.

### BRIEF DESCRIPTION OF THE DRAWINGS

The foregoing and/or additional aspects and advantages of the present application will become apparent and readily understood from the descriptions of the embodiments with reference to the following accompanying drawings, in which:

FIG. 1 is a first schematic structural diagram of a switching power supply circuit according to an embodiment of the present application;

FIG. 2 is a second schematic structural diagram of a switching power supply circuit according to an embodiment of the present application;

FIG. 3 is a third schematic structural diagram of a switching power supply circuit according to an embodiment of the present application;

FIG. 4 is a fourth schematic structural diagram of a switching power supply circuit according to an embodiment of the present application;

FIG. 5 is a fifth schematic structural diagram of a switching power supply circuit according to an embodiment of the present application;

FIG. 6 is a first schematic flowchart of a charging and discharging method according to an embodiment of the present disclosure; and

FIG. 7 is a second schematic flowchart of a charging and discharging method according to an embodiment of the present disclosure.

### REFERENCE NUMERALS

First to second nodes: A1-A2, Capacitor: C, First to eighth power switching transistors: M1-M8, Buck-boost conversion circuit: 100, First auxiliary conversion circuit: 210, Second auxiliary conversion circuit: 220, Control circuit: 300, Adapter: 400.

### Detailed Description of the Embodiments

The embodiments of the present application are described below in detail. The embodiments are shown in the drawings. The same or similar numerals represent the same or similar elements or elements having the same or similar functions throughout the specification. The embodiments described below with reference to the drawings are exemplary, and are merely intended to explain the present application, rather than to limit the present application.

In the following description, “circuit” means an electrically conductive loop consisting of at least one element or subcircuit connected electrically or electromagnetically. When a component or circuit is referred to as “coupled” or “connected” to another component or component/circuit, or “coupled” or “connected” between two nodes, it can be directly coupled or connected to another component or there can be an intermediate component, and the connection between components can be physical, logical, or a combination thereof. Conversely, when an element is referred to as being “directly coupled to” or “directly connected to” another element, it means that there is no intermediate element between the two.

The terms such as “first” and “second” in the present application are used to distinguish between similar objects and are not intended to describe a specific order or sequence. It should be understood that numerical description used in such a way may be interchanged under appropriate circumstances so that the embodiments of the present application can be implemented in an order other than those illustrated or described herein, the objects distinguished by “first”, “second”, etc. are usually of one type, and the number of objects is not limited. For example, one or more first objects may be provided. In addition, “and/or” in the specification and claims indicates at least one of the connected objects, and the character “/” generally indicates an “or” relationship between associated objects.

Moreover, the description with reference to the terms “one embodiment”, “some embodiments”, “exemplary embodiments”, “examples”, or “specific examples” means that specific features, structures, materials, or characteristics described in combination with the embodiments or examples are included in at least one embodiment or example of the present application. In this specification, the schematic representations of the above terms do not necessarily refer to the same embodiment or example. In addition, the specific features, structures, materials, or characteristics described may be combined in any suitable manner in any one or more embodiments or examples.

In related technologies, most switching power supply circuits use power switching transistors to control the on/off of the circuit. Power switching transistors can be metal oxide semiconductor field effect transistors (MOSFETs) or insulated gate bipolar transistors (IGBTs). The following is an example of using a MOSFET as a power switching transistor for explanation.

It can be understood that the switching loss of a MOSFET is Pd−C×V²×f, where C is a parasitic capacitance, V is a voltage, and f is a switching frequency. Therefore, the switching loss Pd is proportional to the square of the voltage. Compared to 100 W charging power at the same current rating of 5 A, the 140 W charging operates at 28V. Since the MOSFET experiences higher voltage stress, the design of the switching power supply circuit necessitates MOSFETs with higher voltage withstand capability. However, under the same internal resistance, MOSFETs with higher voltage withstand capability have larger parasitic capacitance C. Consequently, this leads to increased switching losses. Under 140 W operation, switching losses exceed 1.96 times those at 100 W. Simultaneously, at identical battery voltages, 140 W charging requires 1.4 times current of 100 W charging. The conduction loss of the MOSFET is: Pdron=I²×ron, where I represents on-current, and ron represents on-resistance. Thus, conduction loss under 140 W charging approach approximately 1.96 times those at 100 W.

In summary, conventional switching power supply circuits exhibit reduced charging efficiency and elevated system temperatures when operating at high power levels. Moreover, due to the increase in current, voltage spikes will increase at the instant of switching state transitions of the MOSFET. This elevates the electrical stress on the MOSFET, thereby increasing the risk of MOSFET failure. Taking mobile phones or laptops as an example, the high power can be 140 W (28 5 A), 180 W (36 5 A), or 240 W (48 5 A). In addition, in the field of automotive charging, passenger car batteries typically operate at 12V while commercial trucks utilize 24V. In order to meet the needs of both passenger cars and large trucks, as well as various voltage requirements ranging from 5V to 20V, car chargers commonly operate at 45 W or 65 W. However, with the growing adoption of PD3.1 specification, to meet the power requirements of 140 W (28V 5 A) or even higher, car chargers also suffer from serious heat generation caused by decreased efficiency.

The present application provides a switching power supply circuit, a charging and discharging method, and a charging and discharging device. The switching power supply circuit is equipped with at least two conversion circuits. According to the requirements of charging and discharging, one or multiple conversion circuits can be activated, improving charging efficiency, and achieving boost or buck as needed. When the power is large, the multiple conversion circuits can share the charging power, resulting in reduced current flow through each individual circuit. This mitigates heat generation and lowers the failure risk of power switching transistors.

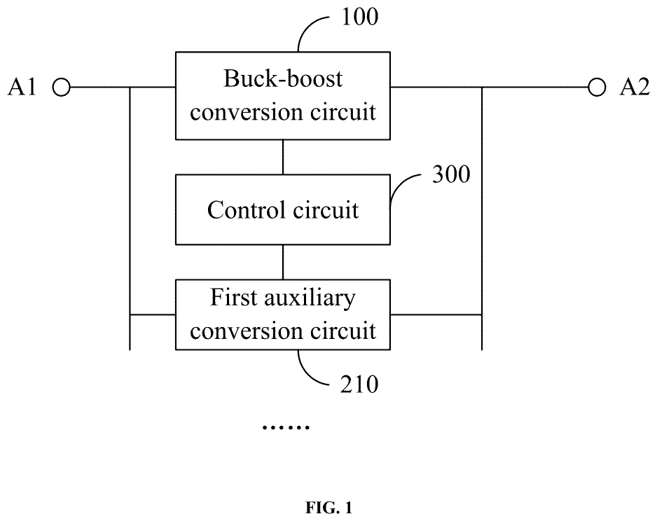

Referring to FIG. 1, one embodiment of the present application provides a switching power supply circuit. In this embodiment, the switching power supply circuit includes a first node A1, a second node A2, a buck-boost conversion circuit 100, at least one first auxiliary conversion circuit 210, and a control circuit 300. During charging, the first node A1 is connected to a power source and the second node A2 outputs power; and during discharging, the first node A1 outputs power and the second node A2 is connected to the power source. The buck-boost conversion circuit 100 is coupled between the first node A1 and the second node A2, and is configured to operate under control in one of the following modes during the charging or the discharging: boost mode, buck mode, or buck-boost mode. The first auxiliary conversion circuit 210 is connected in parallel with the buck-boost conversion circuit 100 and configured to operate under control in the buck mode during the charging or the boost mode during the discharging. The control circuit 300 is coupled to the buck-boost conversion circuit 100 and the first auxiliary conversion circuit 210, and is configured to activate the buck-boost conversion circuit 100 and/or the first auxiliary conversion circuit 210 based on a first voltage at the first node A1 and a second voltage at the second node A2.

It should be noted that the switching power supply circuit can operate in either charging or discharging mode. The first node A1 and the second node A2 serve as the input and output terminals of the switching power supply circuit. In the charging mode, the first node A1 is electrically connected to an external power source (such as an adapter) to connect to the power source; the second node A2 is electrically connected to an electrical unit to output power. The electrical unit can be an electrical circuit or a battery. In the discharging mode, the first node A1 is configured to output power, and the second node A2 is configured to connect the power source.

The buck-boost conversion circuit 100 can achieve boost function, buck function, or buck-boost function under control. For example, in the early stage of charging, the buck-boost conversion circuit 100 operates in boost mode; in the mid-term stage of charging, the buck-boost conversion circuit 100 operates in buck-boost mode; and in the later stage of charging, the buck-boost conversion circuit 100 operates in buck mode. Similarly, during discharging, the buck-boost conversion circuit can switch between boost function, buck function, or buck-boost function.

In this embodiment, the control circuit 300 can simultaneously activate the buck-boost conversion circuit 100 and the first auxiliary conversion circuit 210; and alternatively, the control circuit 300 can activate the buck-boost conversion circuit 100 separately, or the control circuit 300 can activate the first auxiliary conversion circuit 210 separately.

The first auxiliary conversion circuit 210 can be used to achieve buck function during charging or boost function during discharging. During charging, if the first voltage is greater than the second voltage, the buck-boost conversion circuit 100 and the first auxiliary conversion circuit 210 can operate in buck mode. During discharging, if the first voltage is greater than the second voltage, the buck-boost conversion circuit 100 and the first auxiliary conversion circuit 210 can operate in boost mode.

It can be understood that when the buck-boost conversion circuit 100 and the first auxiliary conversion circuit 210 are activated simultaneously, current in each circuit decreases due to power sharing. Taking a switching power supply circuit that includes one buck-boost conversion circuit 100 and one first auxiliary conversion circuit 210 as an example, the current on each circuit drops by ½. Due to Pdron=I2×ron, the conduction loss of the switching transistor in each circuit is reduced by ¼, and the total conduction loss of the switching transistors in the two circuits is reduced by ½, thus significantly reducing power loss, improving efficiency, and reducing system heating. At the same time, due to the fact that the charging power is shared by the two circuits, the current on each circuit drops by ½, so voltage spikes decrease at the instant of switching state transitions of the switching transistor, thereby reducing the electrical stress of the switching transistor and improving safety.

According to the switching power supply circuit of the present application, the switching power supply circuit is equipped with at least two conversion circuits. According to the requirements of charging and discharging, one or multiple conversion circuits can be activated, improving charging efficiency, and achieving boost or buck as needed. When the power is large, the multiple conversion circuits can share the charging power, resulting in reduced current flow through each individual circuit. This mitigates heat generation and lowers the failure risk of power switching transistors.

In some embodiments, the control circuit 300 is configured to simultaneously activate the buck-boost conversion circuit 100 and the first auxiliary conversion circuit 210 when the first voltage is greater than a sum of the second voltage and a threshold voltage.

It should be noted that the threshold voltage is used as a comparison threshold to determine whether the voltage at the first node A1 is too high. During the charging or discharging process, if VBUS>VBAT+VT, both the buck-boost conversion circuit 100 and the first auxiliary conversion circuit 210 are enabled simultaneously. VBUS is the first voltage, VBAT is the second voltage, and VT is the threshold voltage.

If VBUS<VBAT+VT, the current in the switching power supply circuit is small and the loss is low. At this time, one conversion circuit is used for charging and discharging. During charging, the first auxiliary conversion circuit 210 is activated to achieve buck, and during discharging, the first auxiliary conversion circuit 210 is activated to achieve boost. Therefore, only the buck-boost conversion circuit 100 is activated to achieve boost during charging and achieve buck during discharging.

In some embodiments, the control circuit 300 is configured to simultaneously activate the buck-boost conversion circuit 100 and the first auxiliary conversion circuit 210 when the first voltage is greater than the sum of the second voltage and the threshold voltage, and a power of the first node A1 is greater than a reference power.

It should be noted that during charging, the power of the first node A1 is an output power of the power source; and during discharging, the power of the first node A1 is a load power of the first node A1. If the power of the first node A1 is greater than the reference power, it can be determined that the charging or discharging power of the switching power supply circuit is high and the loss is high. On the contrary, the charging or discharging power is low and the loss is low.

In this embodiment, the switching power supply circuit adopts a more refined control flow. In the case of VBUS>VBAT+VT, whether the power of the first node A1 is greater than the reference power is further determined. If VBUS>VBAT+VT and the power of the first node is greater than the reference power, the buck-boost conversion circuit 100 and the first auxiliary conversion circuit 210 are activated simultaneously. If the power of the first node is less than the reference power, the buck-boost conversion circuit 100 is deactivated and the first auxiliary conversion circuit 210 is enabled to charge or discharge the battery.

It can be understood that when the power of the first node is less than the reference power, only one conversion circuit can meet efficiency and heat dissipation requirements due to the low charging or discharging power. The first auxiliary conversion circuit 210 may be a circuit having a single function but high efficiency, while the buck-boost conversion circuit 100 is a circuit having multiple functions and low efficiency. Therefore, enabling the first auxiliary conversion circuit 210 can effectively improve the charging and discharging efficiency and reduce heat generation.

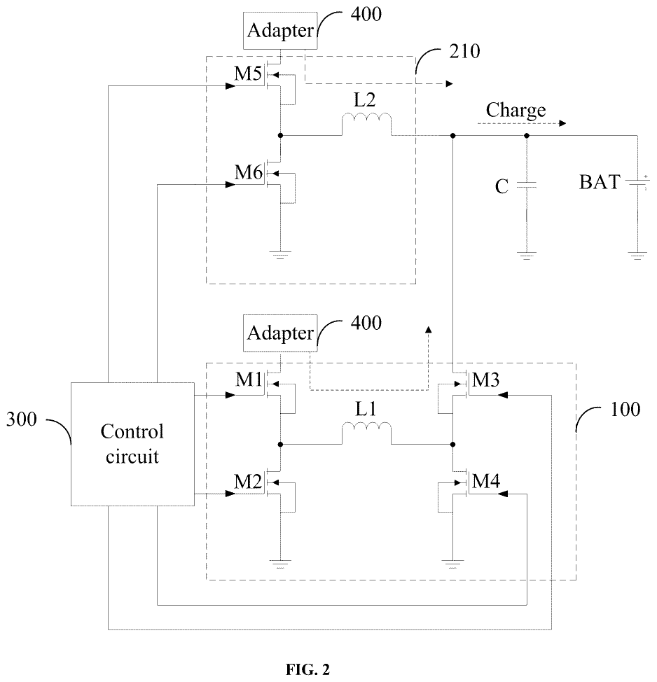

Referring to FIG. 2, by way of example, one embodiment of the present application provides a switching power supply circuit.

In this example, the first node A1 can be coupled to an adapter 400 to connect to the power source. The second node A2 is coupled to a battery BAT to charge the battery BAT. The second node A2 is coupled to one terminal of the capacitor C, and the other terminal of the capacitor C is coupled to a ground node. The capacitor C is used to charge the battery BAT. The MOSFET in each of the buck-boost conversion circuit 100 and the first auxiliary conversion circuit 210 is coupled to the control circuit 300, and the control circuit 300 is used to control on or off of each MOSFET. The following is an example of the switching power supply circuit operating in charging mode.

In some embodiments, the buck-boost conversion circuit 100 includes a first power switching transistor M1, a second power switching transistor M2, a third power switching transistor M3, a fourth power switching transistor M4, and a first inductor L1. The drain of the first power switching transistor M1 is coupled to the first node A1. The drain of the second power switching transistor M2 is coupled to the source of the first power switching transistor M1, and the source of the second power switching transistor M2 is grounded. The drain of the third power switching transistor M3 is coupled to a first terminal of the capacitor C. The drain of the fourth power switching transistor M4 is coupled to the source of the third power switching transistor M3, and the source of the fourth power switching transistor M4 is grounded. The first inductor L1 is coupled between a connection point of the first power switching transistor M1 and the second power switching transistor M2 and a connection point of the third power switching transistor M3 and the fourth power switching transistor M4.

As an example, the first power switching transistor M1, the second power switching transistor M2, the third power switching transistor M3, and the fourth power switching transistor M4 are all N-channel MOSFETs.

When the buck-boost conversion circuit 100 operates in buck mode, the control circuit 300 controls the third power switching transistor M3 to be normally open and the fourth power switching transistor M4 to be normally closed. The buck-boost conversion circuit 100 is equivalent to a buck circuit. At this time, the control circuit 300 can control the first power switching transistor M1 and the second power switching transistor M2 to be turned on or off at a certain switching frequency, such that the voltage at the drain of the third power switching transistor M3 is less than the voltage at the first node A1.

When the first power switching transistor M1 is turned on and the second power switching transistor M2 is turned off, the power output from the adapter 400 is charged through the first inductor L1 and the capacitor C. When the first power switching transistor M1 is turned off and the second power switching transistor M2 is turned on, the first inductor L1 charges the battery BAT to achieve buck function. Thus, when the voltage at the adapter is higher than that at the battery BAT, a voltage lower than that at the first node A1 is provided to the second node A2 for buck charging of the battery BAT.

When the buck-boost conversion circuit 100 operates in boost mode, the control circuit 300 controls the first power switching transistor M1 to be normally open and the second power switching transistor M2 to be normally closed. The buck-boost conversion circuit 100 is equivalent to a boost circuit. At this time, the control circuit 300 can control the third power switching transistor M3 and the fourth power switching transistor M4 to be turned on or off at a certain switching frequency, such that the voltage at the drain of the third power switching transistor M3 is greater than the voltage at the first node A1.

When the third power switching transistor M3 is turned on and the fourth power switching transistor M4 is turned off, the adapter 400 and the first inductor L1 simultaneously charge the capacitor C and the battery BAT. When the third power switching transistor M3 is turned off and the fourth power switching transistor M4 is turned on, the capacitor C charges the battery BAT, achieving the boost function. Thus, when the voltage at the adapter is lower than that at the battery BAT, a voltage greater than that at the first node A1 is provided to the second node A2 for boost charging of the battery BAT.

In some embodiments, the first auxiliary conversion circuit 210 includes a first switch and a second switch connected in series, and a second inductor L2, where one terminal of the first switch is coupled to the first node A1, one terminal of the second switch is coupled to the ground node, and the second inductor L2 is coupled between a connection point of the first switch and the second switch and the second node A2.

Continuing with reference to FIG. 2, the first switch is a fifth power switching transistor M5, and the second switch is a sixth power switching transistor M6. The drain of the fifth power switching transistor M5 is coupled to the first node A1; the drain of the sixth power switching transistor M6 is coupled to the source of the fifth power switching transistor M5, and the source of the sixth power switching transistor M6 is grounded; and the second inductor L2 is coupled between a connection point of the fifth power switching transistor M5 and the sixth power switching transistor M6 and the first terminal of the capacitor C.

In this embodiment, the fifth power switching transistor M5 and the sixth power switching transistor M6 are all N-channel MOSFETs.

The control circuit 300 can control the fifth power switching transistor M5 and the sixth power switching transistor M6 to be turned on or off at a certain switching frequency, such that the voltage at the terminal of the second inductor L2 connected to the first terminal of the capacitor C is less than the voltage at the first node A1. Thus, in the early stage of charging the battery BAT, a lower voltage is provided to the second node A2 to charge the battery BAT. The principle of buck is the same as that when the buck-boost conversion circuit 100 is equivalent to a buck circuit, as described above.

It should be noted that the switching power supply circuit shown in FIG. 2 can also operate in discharging mode. At this time, the switching power supply circuit outputs the power of the battery BAT to the outside through the first node A1 to supply power to the load.

In some embodiments, the buck-boost conversion circuit 100 and the first auxiliary conversion circuit 210 are configured to provide currents of different phases.

As an example, the buck-boost conversion circuit 100 provides a current of a first phase under the control of the control circuit 300, and the first auxiliary conversion circuit 210 provides a current of a second phase under the control of the control circuit 300. The control circuit 300 adjusts a phase difference between the first phase and the second phase by adjusting a timing difference between a first control signal output to the buck-boost conversion circuit 100 and a second control signal output to the first auxiliary conversion circuit 210. The principle of phase control has mature technology, and this implementation will not be repeated here. By utilizing a multi-phase switching power supply for charging, the charging efficiency can be improved.

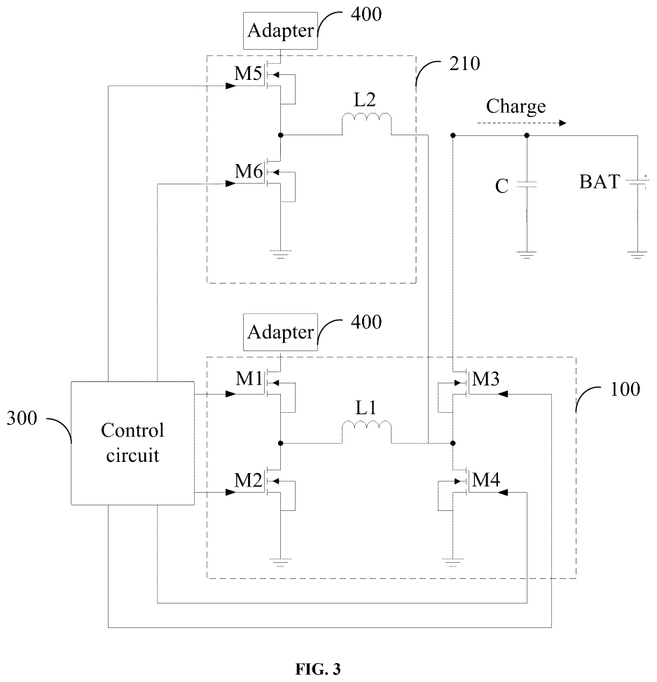

Referring to FIG. 3, FIG. 3 shows a modified switching power supply circuit of the switching power supply circuit shown in FIG. 2. The switching power supply circuit shown in FIG. 3 can also achieve the same function as the switching power supply circuit shown in FIG. 2.

In some embodiments, the connection point of the fifth power switching transistor M5 and the sixth power switching transistor M6 in the first auxiliary conversion circuit 210 is connected to one terminal of the inductor L2, and the other terminal of the inductor L2 is coupled to the connection point of the third power switching transistor M3 and the fourth power switching transistor M4. When the first auxiliary conversion circuit 210 needs to operate, the third power switching transistor M3 is controlled to be normally open and the fourth power switching transistor M4 is controlled to be normally closed. At this point, the first power switching transistor M1 and the second power switching transistor M2 are switched to the same power topology as that of the fifth power switching transistor M5 and the sixth power switching transistor M6, and can also form a two-phase switching power supply.

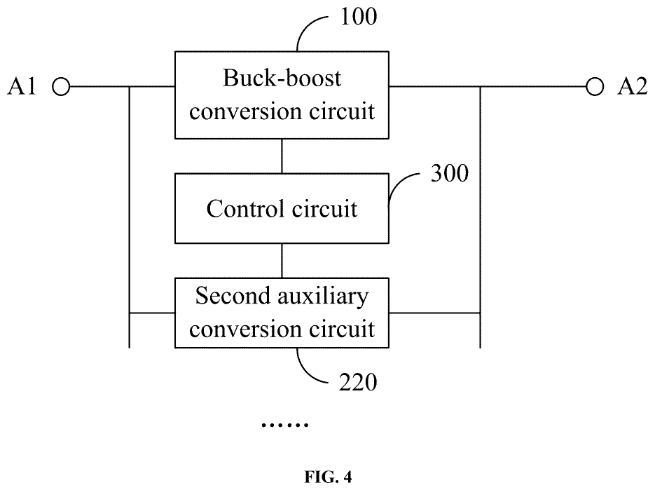

Referring to FIG. 4, one embodiment of the present application provides a switching power supply circuit. In this embodiment, the switching power supply circuit includes a first node A1, a second node A2, a buck-boost conversion circuit 100, at least one second auxiliary conversion circuit 220, and a control circuit 300. During charging, the first node A1 is connected to a power source and the second node A2 outputs power; and during discharging, the first node Al outputs power and the second node A2 is connected to the power source. The buck-boost conversion circuit 100 is coupled between the first node A1 and the second node A2, and is configured to operate under control in one of the following modes during the charging or the discharging: boost mode, buck mode, or buck-boost mode. The second auxiliary conversion circuit 220 is connected in parallel with the buck-boost conversion circuit 100 and configured to operate under control in the boost mode during the charging or the buck mode during the discharging. The control circuit 300 is coupled to the buck-boost conversion circuit 100 and the second auxiliary conversion circuit 220, and is configured to activate the buck-boost conversion circuit 100 and/or the second auxiliary conversion circuit 220 based on a first voltage at the first node A1 and a second voltage at the second node A2.

In this embodiment, the structure and principle of the buck-boost conversion circuit 100 can refer to the previous embodiments, and this embodiment will not be repeated here.

In this embodiment, the control circuit 300 can simultaneously activate the buck-boost conversion circuit 100 and the second auxiliary conversion circuit 220; and alternatively, the control circuit 300 can activate the buck-boost conversion circuit 100 separately, or the control circuit 300 can activate the second auxiliary conversion circuit 220 separately.

The second auxiliary conversion circuit 220 can be used to achieve boost function during charging or buck function during discharging. During charging, if the first voltage is less than the second voltage, the buck-boost conversion circuit 100 and the second auxiliary conversion circuit 220 can operate in boost mode. During discharging, if the first voltage is less than the second voltage, the buck-boost conversion circuit 100 and the second auxiliary conversion circuit 220 can operate in buck mode.

It can be understood that when the buck-boost conversion circuit 100 and the second auxiliary conversion circuit 220 are activated simultaneously, current in each circuit decreases due to power sharing. The conduction loss of each switching transistor decreases, and the total conduction loss of the switching transistors decreases, improving efficiency, and reducing system heating. At the same time, due to the fact that the charging power is shared by the two circuits, the current on each circuit decreases, so voltage spikes decrease at the instant of switching state transitions of the switching transistor, thereby reducing the electrical stress of the switching transistor and improving safety.

According to the switching power supply circuit of the present application, the switching power supply circuit is equipped with at least two conversion circuits. According to the requirements of charging and discharging, one or multiple conversion circuits can be activated, improving charging efficiency, and achieving boost or buck as needed. When the power is large, the multiple conversion circuits can share the charging power, resulting in reduced current flow through each individual circuit. This mitigates heat generation and lowers the failure risk of power switching transistors.

In some embodiments, the control circuit 300 is configured to simultaneously activate the buck-boost conversion circuit 100 and the second auxiliary conversion circuit 220 when the second voltage is greater than a sum of the first voltage and a threshold voltage.

It should be noted that the threshold voltage is used as a comparison threshold to determine whether the voltage at the first node A1 is too high. During the discharging process, when the second node is connected to the power source, if VBAT>VBUS+VT, both the buck-boost conversion circuit 100 and the second auxiliary conversion circuit 220 are enabled simultaneously. VBUS is the first voltage, VBAT is the second voltage, and VT is the threshold voltage.

If VBAT<VBUS+VT, the current in the switching power supply circuit is small and the loss is low. At this time, one conversion circuit is used for charging and discharging. During charging, the second auxiliary conversion circuit 220 is activated to achieve boost, and during discharging, the first auxiliary conversion circuit 210 is activated to achieve buck. Therefore, only the buck-boost conversion circuit 100 is activated to achieve boost during charging and achieve buck during discharging.

In some embodiments, the control circuit 300 is configured to simultaneously activate the buck-boost conversion circuit 100 and the second auxiliary conversion circuit 220 when the second voltage is greater than the sum of the first voltage and the threshold voltage, and a power of the first node A1 is greater than a reference power.

It can be understood that if the power of the first node A1 is greater than the reference power, it can be determined that the charging or discharging power of the switching power supply circuit is high and the loss is high. On the contrary, the charging or discharging power is low, and the loss is low.

In this embodiment, the switching power supply circuit adopts a more refined control flow. In the case of VBAT>VBUS+VT, whether the power of the first node A1 is greater than the reference power is further determined. If VBAT>VBUS+VT and the power of the first node is greater than the reference power, the buck-boost conversion circuit 100 and the second auxiliary conversion circuit 220 are activated simultaneously. If the power of the first node is less than the reference power, the buck-boost conversion circuit 100 is deactivated and the second auxiliary conversion circuit 220 is enabled to charge or discharge the battery.

It can be understood that when the power of the first node is less than the reference power, only one conversion circuit can meet efficiency and heat dissipation requirements due to the low charging or discharging power. The second auxiliary conversion circuit 220 may be a circuit having a single function but high efficiency, while the buck-boost conversion circuit 100 is a circuit having multiple functions and low efficiency. Therefore, enabling the second auxiliary conversion circuit 220 can effectively improve the charging and discharging efficiency and reduce heat generation.

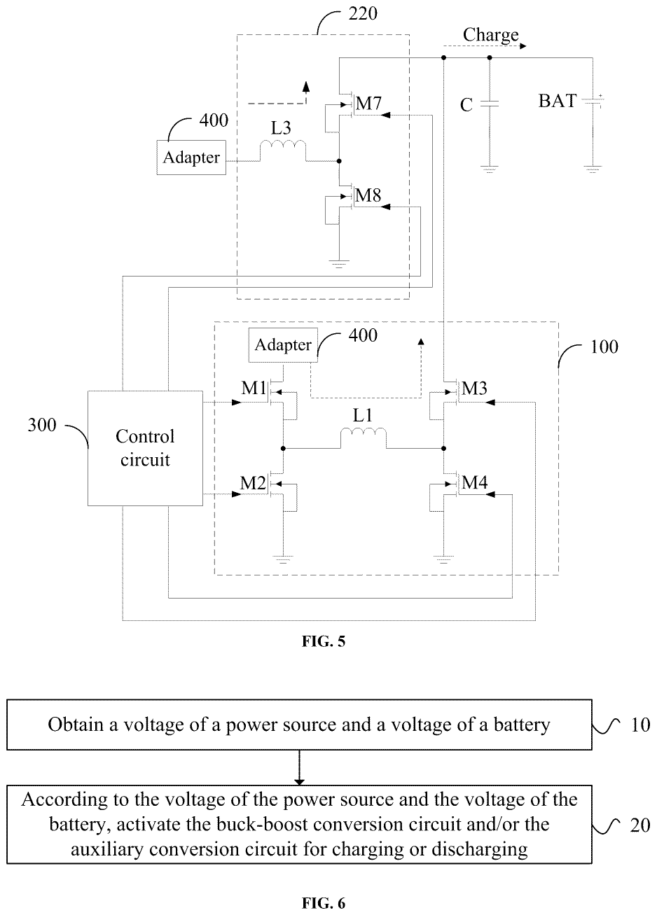

Referring to FIG. 5, by way of example, one embodiment of the present application provides a switching power supply circuit.

In this example, the structure of the buck-boost conversion circuit 100 is the same as that shown in FIG. 2, so the principle of the buck-boost conversion circuit 100 will not be repeated here.

In some embodiments, the second auxiliary conversion circuit 220 includes a third switch and a fourth switch connected in series, and a third inductor L3, where one terminal of the third switch is coupled to the second node A2, one terminal of the fourth switch is coupled to the ground node, and the third inductor L3 is coupled between a connection point of the third switch and the fourth switch and the first node A1.

The third switch is a seventh power switching transistor M7 and the fourth switch is an eighth power switching transistor M8. The drain of the seventh power switching transistor M7 is coupled to the first terminal of the capacitor C, the drain of the eighth power switching transistor M8 is coupled to the source of the seventh power switching transistor M7, and the source of the eighth power switching transistor M8 is grounded; and the third inductor L3 is coupled between a connection point of the seventh power switching transistor M7 and the eighth power switching transistor M8 and the first node A1.

In this embodiment, the seventh power switching transistor M7 and the eighth power switching transistor M8 are all N-channel MOSFETs.

The control circuit 300 can control the seventh power switching transistor M7 and the eighth power switching transistor M8 to be turned on or off at a certain switching frequency, such that the voltage at the drain of the seventh power switching transistor M7 is greater than the voltage at the first node A1. Thus, in the later stage of charging the battery BAT, a higher voltage is provided to the second node A2 to charge the battery BAT. The principle of boost is the same as that when the buck-boost conversion circuit 100 is equivalent to a boost circuit, as described above.

It should be noted that the switching power supply circuit shown in FIG. 5 can also operate in discharging mode. At this time, the switching power supply circuit outputs the power of the battery BAT to the outside through the first node A1 to supply power to the load.

In some embodiments, the buck-boost conversion circuit 100 and the second auxiliary conversion circuit 220 are configured to provide currents of different phases. The control method can refer to the above, and this embodiment will not be repeated here.

Referring to FIG. 6, one embodiment of the present application provides a charging and discharging method, which is used for controlling, based on the aforementioned switching power supply circuit, the first node A1 of the switching power supply circuit to be coupled to a power source, and the second node to be coupled to the battery BAT. The specific structure of the switching power supply circuit can refer to the above.

In this embodiment, the charging and discharging method includes:
Step 10: obtain a voltage of the power source and a voltage of the battery; and
Step 20: according to the voltage of the power source and the voltage of the battery, activate the buck-boost conversion circuit and/or the auxiliary conversion circuit for charging or discharging.

It should be noted that the executing subject of the charging and discharging method provided in this embodiment may be the control circuit 300 in the switching power supply circuit. The control circuit 300 may include a microcontroller unit (MCU), which has functions such as data communication, analysis, and computation.

It should be noted that the switching power supply circuit can perform charging and discharging. The first node A1 can be coupled to an adapter 400, and the second node A2 can be coupled to the battery BAT. During charging, the power source serves as an input power source; and during discharging, the battery serves as an input power source.

In some embodiments, both the adapter 400 and the battery BAT are equipped with a monitoring unit that can detect voltage. The control circuit 300 is connected to the monitoring unit of the adapter 400 to obtain the power voltage. The control circuit 300 is connected to the monitoring unit of the battery BAT to obtain the battery voltage.

In this embodiment, enabling the buck-boost conversion circuit 100 refers to that the control circuit 300 controls the buck-boost conversion circuit 100 to operate in boost mode, buck mode, or buck-boost mode. Enabling the auxiliary conversion circuit refers to that the control circuit 300 controls the auxiliary conversion circuit to operate with a corresponding function.

The auxiliary conversion circuit can be the aforementioned first auxiliary conversion circuit 210 or second auxiliary conversion circuit 220, and the control circuit 300 executes different control logics according to the different functions of the auxiliary conversion circuits. If the auxiliary conversion circuit is the first auxiliary conversion circuit 210, the control circuit 300 simultaneously activates the buck-boost conversion circuit 100 and the first auxiliary conversion circuit 210 when VBUS>VBAT+VT. If the auxiliary conversion circuit is the second auxiliary conversion circuit 220, the control circuit 300 simultaneously activates the buck-boost conversion circuit 100 and the second auxiliary conversion circuit 220 when VBAT>VBUS+VT. VBUS is the power voltage, VBAT is the battery voltage, and VT is the threshold voltage.

According to the charging and discharging method of the present application, based on the requirements of charging and discharging, one or multiple conversion circuits can be activated, improving charging efficiency, and achieving boost or buck as needed. When the power is large, the multiple conversion circuits can share the charging power, resulting in reduced current flow through each individual circuit. This mitigates heat generation and lowers the failure risk of power switching transistors.

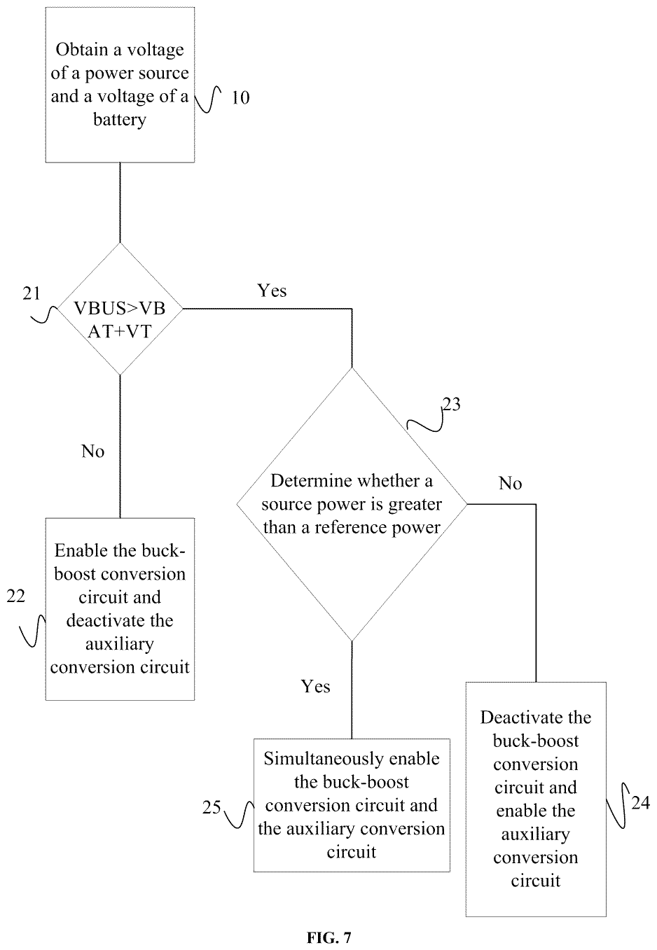

Referring to FIG. 7, in some embodiments, the charging and discharging method includes the following control flow:
Step 10: obtain a voltage of the power source and a voltage of the battery;
Step 21: Determine whether VBUS>VBAT+VT; if not, proceed to step 22; if yes, proceed to step 23;
Step 22: Enable the buck-boost conversion circuit and deactivate the auxiliary conversion circuit;
Step 23: Determine whether a source power is greater than the reference power; if not, proceed to step 24; if yes, proceed to step 25;
Step 24: Deactivate the buck-boost conversion circuit and enable the auxiliary conversion circuit; and
Step 25: Simultaneously enable the buck-boost conversion circuit and the auxiliary conversion circuit.

It should be noted that the source power refers to the output power of the power source. If the source power is greater than the reference power, it can be determined that the charging or discharging power of the switching power supply circuit is high and the loss is high. On the contrary, the charging or discharging power is low and the loss is low.

In this embodiment, the switching power supply circuit adopts a more refined control flow. In the case of VBUS>VBAT+VT, whether the source power is greater than the reference power is further determined. If VBUS>VBAT+VT and the source power is less than the reference power, the buck-boost conversion circuit 100 is deactivated, and the auxiliary conversion circuit is enabled to charge or discharge the battery.

It can be understood that when the source power is less than the reference power, only one conversion circuit can meet efficiency and heat dissipation requirements due to the low charging or discharging power. In addition, the buck-boost conversion circuit 100 is a multi-function circuit, and has efficiency lower than that of the auxiliary conversion circuit. Therefore, enabling the auxiliary conversion circuit can effectively improve the charging and discharging efficiency and reduce heat generation.

If VBUS>VBAT+VT and the source power is greater than the reference power, it indicates that the charging and discharging power is very high, and the loss of a single conversion circuit is relatively high. Therefore, it is necessary to activate at least two conversion circuits, so as to improve the charging and discharging efficiency and reduce heat generation.

Taking the switching power supply circuit shown in FIG. 2 as an example, deactivating the buck-boost conversion circuit 100 refers to controlling the first power switching transistor M1, the second power switching transistor M2, the third power switching transistor M3, and the fourth power switching transistor M4 to be turned off. Enabling the buck-boost conversion circuit 100 refers to controlling the buck-boost conversion circuit 100 to operate in boost mode, buck mode, or buck-boost mode; and deactivating the auxiliary conversion circuit refers to controlling the fifth power switching transistor M5 and the sixth power switching transistor M6 to be turned off. Enabling the auxiliary conversion circuit refers to controlling the fifth power switching transistor M5 and the sixth power switching transistor M6 to switch from on and off according to a set switching frequency. The working process of the buck-boost conversion circuit 100 and the auxiliary conversion circuit in the enabled state can refer to the previous embodiment.

One embodiment of the present application provides a charging and discharging device, where the charging and discharging device includes the aforementioned switching power supply circuit.

In some embodiments, the charging and discharging device may be a mobile phone, laptop, or car charger, etc.

According to the charging and discharging device of the present application, the switching power supply circuit is equipped with at least two conversion circuits. Each conversion circuit can share the charging power, reducing the current in each conversion circuit, mitigating heat generation, and reducing the loss risk of power switching transistors in the switching power supply circuit.

According to the switching power supply circuit, the charging and discharging method, and the charging and discharging device of the present application, the switching power supply circuit is equipped with at least two conversion circuits. According to the requirements of charging and discharging, one or multiple conversion circuits can be activated, improving charging efficiency, and achieving boost or buck as needed. When the power is large, the multiple conversion circuits can share the charging power, resulting in reduced current flow through each individual circuit. This mitigates heat generation and lowers the failure risk of power switching transistors.

Although the examples of this application have been illustrated and described, a person of ordinary skill in the art can understand that various changes, modifications, replacements, and variants may be made to these examples without departing from the principle and purpose of this application, and the scope of this application is defined by the claims and equivalents thereof.

1. A switching power supply circuit, comprising:
a first node and a second node, wherein during charging, the first node is connected to a power source and the second node outputs power; and during discharging, the first node outputs power and the second node is connected to the power source;
a buck-boost conversion circuit, coupled between the first node and the second node, and configured to operate under control in one of the following modes during the charging or the discharging: boost mode, buck mode, or buck-boost mode;
at least one first auxiliary conversion circuit, connected in parallel with the buck-boost conversion circuit, and configured to operate under control in the buck mode during the charging or the boost mode during the discharging; and
a control circuit, coupled to the buck-boost conversion circuit and the first auxiliary conversion circuit, and configured to activate the buck-boost conversion circuit and/or the first auxiliary conversion circuit based on a first voltage at the first node and a second voltage at the second node.

2. The switching power supply circuit according to claim 1, wherein the control circuit is configured to simultaneously activate the buck-boost conversion circuit and the first auxiliary conversion circuit when the first voltage is greater than a sum of the second voltage and a threshold voltage.

3. The switching power supply circuit according to claim 2, wherein the control circuit is configured to simultaneously activate the buck-boost conversion circuit and the first auxiliary conversion circuit when the first voltage is greater than the sum of the second voltage and the threshold voltage, and a power of the first node is greater than a reference power.

4. The switching power supply circuit according to claim 1, wherein the first auxiliary conversion circuit comprises:
a first switch and a second switch connected in series, wherein one terminal of the first switch is coupled to the first node, and one terminal of the second switch is coupled to a ground node; and
an inductor, coupled between a connection point of the first switch and the second switch and the second node.

5. A switching power supply circuit, comprising:
a first node and a second node, wherein during charging, the first node is connected to a power source and the second node outputs power; and during discharging, the first node outputs power and the second node is connected to the power source;
a buck-boost conversion circuit, coupled between the first node and the second node, and configured to operate under control in one of the following modes during the charging or the discharging: boost mode, buck mode, or buck-boost mode;
at least one second auxiliary conversion circuit, connected in parallel with the buck-boost conversion circuit, and configured to operate under control in the boost mode during the charging or the buck mode during the discharging; and
a control circuit, coupled to the buck-boost conversion circuit and the second auxiliary conversion circuit, and configured to activate the buck-boost conversion circuit and/or the second auxiliary conversion circuit based on a first voltage at the first node and a second voltage at the second node.

6. The switching power supply circuit according to claim 5, wherein the control circuit is configured to simultaneously activate the buck-boost conversion circuit and the second auxiliary conversion circuit when the second voltage is greater than a sum of the first voltage and a threshold voltage.

7. The switching power supply circuit according to claim 6, wherein the control circuit is configured to simultaneously activate the buck-boost conversion circuit and the second auxiliary conversion circuit when the second voltage is greater than the sum of the first voltage and the threshold voltage, and a power of the first node is greater than a reference power.

8. The switching power supply circuit according to claim 5, wherein the second auxiliary conversion circuit comprises:
a third switch and a fourth switch connected in series, wherein one terminal of the third switch is coupled to the second node, and one terminal of the fourth switch is coupled to a ground node; and
an inductor, coupled between a connection point of the third switch and the fourth switch and the first node.

9. A charging and discharging method, used for controlling, based on the switching power supply circuit according to claim 1, the first node of the switching power supply circuit to be coupled to the power source, and the second node to be coupled to a battery, wherein the charging and discharging method comprises:
obtaining a voltage of the power source and a voltage of the battery; and
according to the voltage of the power source and the voltage of the battery, activating the buck-boost conversion circuit and/or the auxiliary conversion circuit for charging or discharging.

10. A charging and discharging device, wherein the charging and discharging device comprises the switching power supply circuit according to claim lany

11. The switching power supply circuit according to claim 2, wherein the first auxiliary conversion circuit comprises:
a first switch and a second switch connected in series, wherein one terminal of the first switch is coupled to the first node, and one terminal of the second switch is coupled to a ground node; and
an inductor, coupled between a connection point of the first switch and the second switch and the second node.

12. The switching power supply circuit according to claim 3, wherein the first auxiliary conversion circuit comprises:
a first switch and a second switch connected in series, wherein one terminal of the first switch is coupled to the first node, and one terminal of the second switch is coupled to a ground node; and
an inductor, coupled between a connection point of the first switch and the second switch and the second node.

13. The switching power supply circuit according to claim 6, wherein the second auxiliary conversion circuit comprises:
a third switch and a fourth switch connected in series, wherein one terminal of the third switch is coupled to the second node, and one terminal of the fourth switch is coupled to a ground node; and
an inductor, coupled between a connection point of the third switch and the fourth switch and the first node.

14. The switching power supply circuit according to claim 7, wherein the second auxiliary conversion circuit comprises:
a third switch and a fourth switch connected in series, wherein one terminal of the third switch is coupled to the second node, and one terminal of the fourth switch is coupled to a ground node; and
an inductor, coupled between a connection point of the third switch and the fourth switch and the first node.

15. A charging and discharging method, used for controlling, based on the switching power supply circuit according to claim 2, the first node of the switching power supply circuit to be coupled to the power source, and the second node to be coupled to a battery, wherein the charging and discharging method comprises:
obtaining a voltage of the power source and a voltage of the battery; and
according to the voltage of the power source and the voltage of the battery, activating the buck-boost conversion circuit and/or the auxiliary conversion circuit for charging or discharging.

16. A charging and discharging method, used for controlling, based on the switching power supply circuit according to claim 3, the first node of the switching power supply circuit to be coupled to the power source, and the second node to be coupled to a battery, wherein the charging and discharging method comprises:
obtaining a voltage of the power source and a voltage of the battery; and
according to the voltage of the power source and the voltage of the battery, activating the buck-boost conversion circuit and/or the auxiliary conversion circuit for charging or discharging.

17. A charging and discharging method, used for controlling, based on the switching power supply circuit according to claim 4, the first node of the switching power supply circuit to be coupled to the power source, and the second node to be coupled to a battery, wherein the charging and discharging method comprises:
obtaining a voltage of the power source and a voltage of the battery; and
according to the voltage of the power source and the voltage of the battery, activating the buck-boost conversion circuit and/or the auxiliary conversion circuit for charging or discharging.

18. A charging and discharging method, used for controlling, based on the switching power supply circuit according to claim 5, the first node of the switching power supply circuit to be coupled to the power source, and the second node to be coupled to a battery, wherein the charging and discharging method comprises:
obtaining a voltage of the power source and a voltage of the battery; and
according to the voltage of the power source and the voltage of the battery, activating the buck-boost conversion circuit and/or the auxiliary conversion circuit for charging or discharging.

19. A charging and discharging method, used for controlling, based on the switching power supply circuit according to claim 6, the first node of the switching power supply circuit to be coupled to the power source, and the second node to be coupled to a battery, wherein the charging and discharging method comprises:
obtaining a voltage of the power source and a voltage of the battery; and
according to the voltage of the power source and the voltage of the battery, activating the buck-boost conversion circuit and/or the auxiliary conversion circuit for charging or discharging.

20. A charging and discharging method, used for controlling, based on the switching power supply circuit according to claim 7, the first node of the switching power supply circuit to be coupled to the power source, and the second node to be coupled to a battery, wherein the charging and discharging method comprises:
obtaining a voltage of the power source and a voltage of the battery; and
according to the voltage of the power source and the voltage of the battery, activating the buck-boost conversion circuit and/or the auxiliary conversion circuit for charging or discharging.
